(19) United States
(12) Patent Application Publication
(10) Pub. No.: US 2026/0012310 A1
(43) Pub. Date: Jan. 8, 2026

(54) AN EFFICIENT RESOURCE ELEMENT MAPPER SYSTEM AND METHOD THEREOF TO HANDLE CONCURRENT TASKS

(71) Applicant: JIO PLATFORMS LIMITED, Ahmedabad, Gujarat (IN)

(72) Inventors: Vinod Kumar SINGH, Navi Mumbai, Maharashtra (IN); Veera Sai Satyanarayana Prasad MARNI, Navi Mumbai, Maharashtra (IN); Hiren PATEL, Navi Mumbai, Maharashtra (IN); Vishal Kumar RAI, Punjab (IN); Aayush BHATNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/992,627

(22) PCT Filed: Nov. 28, 2023
(86) PCT No.: PCT/IB2023/061953

§ 371 Date: Jan. 9, 2025

(30) Foreign Application Priority Data
Nov. 29, 2022 (IN) 202221068817

(51) Int. Cl. H04L 5/00

(52) U.S. Cl. CPC H04L 5/0051; H04L 5/0044

(57) ABSTRACT

The present disclosure relates to a system (208) and a method thereof for managing resource element mapping. The system (208) generates data corresponding to downlink channels that include at least one of: a PSS, a SSS, a DMRS for a PBCH, and a CSIRS. Further, the system (208) receives data from processing chains at data reception modules. The processing chains correspond to a PBCH and a PDCCH, a PDSCH, a DMRS for the PDCCH and the PDSCH. Also, the system (208) stores the generated data and the received data in a buffer and maps the stored data at one or more data dispatch entities (226) at an appropriate position in a slot grid. Further, the system (208) transfers the mapped data, by the one or more data dispatch entities (226), serially to a modulator (306) based on a frequency and a time of a resource element of the slot grid.

### RESERVATION OF RIGHTS

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of wireless communication, and specifically to a system and a method for providing a Resource Element (RE) mapper design in a single FPGA platform.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Physical layer (Layer 1) of base station-processes various channels/chains in downlink (transmission) and in uplink (reception). Data of each of the chain that is to be transmitted goes through its unique channel process. However, each of individual chain's processes are quite complex, and to handle data generation from each of the chain's processes is a complex task. For example, in the downlink, various chains (such as Physical Downlink Shared Channel (PDSCH), Physical Downlink Control Channel (PDCCH), and Synchronization Signal Block (SSB)) generate the data. These various data streams are required to be mapped to the slot grid for on-air transmission all the while managing each of the chain's output and synchronization between them. This mapping task is a huge burden in the Field Programmable Gate Arrays (FPGA) implementation because the FPGA is required to handle data from multiple parallel processes along with managing data storage requirement.

There is therefore, a need in the art for an improved system and method to provide a single module in the FPGA for carrying multiple entities/functions that are capable of handling inputs from various data generation processes, and local data generation along with concurrent mapping of data onto output slot grid while reducing complexity of overall implementation and efficient management of FPGA resources.

### OBJECTS OF THE PRESENT DISCLOSURE

It is an object of the present disclosure to provide a system and a method for providing a resource element mapper design in a single FPGA platform.

It is an object of the present invention to provide a system and a method for strengthening base station implementation in the FPGA platform.

It is an object of the present invention to provide a single hardware module for handling data collection, data generation and data dispatch entities concurrently.

It is an object of the present disclosure to create parallel sub-data collection entities within master data collection entity.

It is an object of the present disclosure to create serial sub-data generation entities within the master data generation entity.

It is an object of the present disclosure to create a data dispatch entity which serially outputs stored data and which works parallel to data collection and generation entities.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for managing resource element mapping. The system includes one or more processors and a memory operatively coupled to the one or more processors, wherein the memory comprises processor-executable instructions, which on execution, cause the one or more processors to generate data corresponding to one or more downlink channels at one or more data generation modules associated with the system, wherein the one or more downlink channels comprise at least one of: a Primary Synchronization Signal (PSS), a Secondary Synchronization Signal (SSS), a Demodulated Reference Signal (DMRS) for a Physical Broadcast Channel (PBCH), and a Channel State Information Reference Signal (CSIRS). Further, the one or more processors to receive data from one or more processing channels at one or more data reception modules associated with the system, wherein the one or more processing channels are corresponding to a PBCH and a Physical Downlink Control Channel (PDCCH), a Physical Downlink Shared Channel (PDSCH), a DMRS for the PDCCH and the PDSCH. Also, the one or more processors to store the generated data and the received data in a buffer associated with the system and map the stored data at one or more data dispatch entities associated with the system at an appropriate position in a slot grid. Further, the one or more processors to transfer the mapped data, by the one or more data dispatch entities associated with the system, serially to a modulator block associated with the system based on a frequency and a time of the resource element of the slot grid.

In an embodiment, the data corresponding to the PSS is generated serially with the SSS.

In an embodiment, the information corresponding to the PBCH is received serially with the PDCCH.

In an embodiment, the data generation and the data reception are performed concurrently.

In an embodiment, the one or more processors may receive mapping information from a slot tag grid associated with the system. Also, the one or more processors may determine both the generated data and the received data are completely stored in the buffer and may sequentially fetch the stored data from the buffer using the mapping information to map the fetched data at the appropriate position in the slot grid.

In an embodiment, the slot tag grid comprises the mapping information of the allocated physical downlink channels for each of the Physical Resource Blocks (PRBs) of the slot grid.

In an embodiment, the one or more processors may determine that a previous slot of the buffer is filled and a current slot of the buffer is being utilizing for storing the generated data and the received data and in response to the determination, and the one or more processors may fetch the data from the previous slot of the buffer to map the fetched data at the appropriate position in the slot grid.

In another aspect, the present disclosure relates to a method for managing resource element mapping. The method includes generating, by the one or more processors, data corresponding to one or more downlink channels at one or more data generation modules associated with a system, wherein the one or more downlink channels comprise at least one of: a Primary Synchronization Signal (PSS), a Secondary Synchronization Signal (SSS), a Demodulated Reference Signal (DMRS) for a Physical Broadcast Channel (PBCH), and a Channel State Information Reference Signal (CSIRS). Also, the method includes, receiving, by the one or more processors, data from a plurality of processing channels at one or more data reception modules associated with the system, wherein the one or more processing channels are corresponding to a PBCH, a Physical Downlink Control Channel (PDCCH), a Physical Downlink Shared Channel (PDSCH), a DMRS value for the PDCCH and the PDSCH. Further, the method includes storing, by the one or more processors, the generated data and the received data in the buffer associated with the system and mapping, at one or more data dispatch entities associated with the system, the stored data at an appropriate position in a slot grid. Also, the method includes transferring, by the one or more data dispatch entities associated with the system, the mapped data serially to a modulator block associated with the system based on a frequency and a time of the resource element of the slot grid.

In an embodiment, the method may include receiving, by the one or more processors, mapping information from a slot tag grid associated with the system. Also, the method may include determining, by the one or more processors, both the generated data and the received data are completely stored in the buffer. Further, the method may include sequentially fetching, by the one or more processors, the stored data from the buffer using the mapping information to map the fetched data at the appropriate position in the slot grid.

In an embodiment, the method may include determining, by the one or more processors, that a previous slot of the buffer is filled and a current slot of the buffer is being utilizing for storing the generated data and the received data and in response to the determination, fetching, by the one or more processors, the data from the previous slot of the buffer to map the fetched data at the appropriate position in the slot grid.

In another aspect, the present disclosure relates to a system for managing resource element de-mapping. The system includes one or more processors, and a memory operatively coupled to the one or more processors, wherein the memory includes processor-executable instructions, which on execution, cause the one or more processors to receive mapped slot data serially corresponding to one or more uplink channels, wherein the one or more uplink channels comprises at least one of: a Physical Uplink Shared Channel (PUSCH), a Physical Uplink Control Channel (PUCCH), and a Sounding Reference Signal (SRS). Further, the one or more processors are to de-map the mapped data using a slot tag grid and output the de-mapped data in parallel using data dispatch entities to different uplink processing chains to decode the de-mapped data.

In another aspect, the present disclosure relates to a non-transitory computer-readable medium including processor-executable instructions that cause a processor to generate data corresponding to one or more downlink channels at one or more data generation modules associated with the system, wherein the one or more downlink channels comprise at least one of: a Primary Synchronization Signal (PSS), a Secondary Synchronization Signal (SSS), a Demodulated Reference Signal (DMRS) for a Physical Broadcast Channel (PBCH), and a Channel State Information Reference Signal (CSIRS). Also, the processor to receive data from one or more processing channels at one or more data reception modules associated with the system, wherein the one or more processing channels are corresponding to a PBCH and a Physical Downlink Control Channel (PDCCH), a Physical Downlink Shared Channel (PDSCH), a DMRS for the PDCCH and the PDSCH. Further, the processor to store the generated data and the received data in a buffer associated with the system and map the stored data at one or more data dispatch entities associated with the system at an appropriate position in a slot grid. The processor to transfer, by the one or more data dispatch entities, the mapped data serially to a modulator block associated with the system based on a frequency and a time of the resource element of the slot grid.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary representation (100) for handling resource element mapping process of downlink in Field Programmable Gate Arrays (FPGA), according to conventional approaches.

FIG. 2A illustrates an exemplary network architecture (200A) in which or with which embodiments of the present disclosure may be implemented.

FIG. 2B illustrates an exemplary block diagram (200B) of a system (208), in accordance with an embodiment of the present disclosure.

FIG. 3A illustrates an exemplary representation (300A) of a RE-Mapper FPGA block (302), in accordance with an embodiment of the disclosure.

FIG. 3B illustrates an exemplary representation (300B) of downlink slot containing various physical channels mapped onto slot grid, in accordance with an embodiment of the present disclosure.

FIG. 3C illustrates an exemplary representation (300C) for storing and mapping data alternatively, in accordance with an embodiment of the disclosure.

FIG. 4 illustrates an exemplary computer system (400) in which or with which embodiments of the present disclosure may be implemented.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting to the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In a 5G New Radio (NR) wireless communication technology, layer 1 of base station consists of various downlink and uplink physical channels as defined by 3rd Generation Partnership Project (3GPP) standards. In the downlink, there is a Synchronization Signal Block (SSB) which includes a Primary Synchronization Signal (PSS), Secondary Synchronization Signal (SSS), a Physical Broadcast Channel (PBCH), a Physical Downlink Control Channel (PDCCH), a Physical Downlink Shared Channel (PDSCH) and Channel State Information Reference Signal (CSIRS) channels which are transmitted. In the uplink, there are a Physical Uplink Shared Channel (PUSCH), a Physical Random Access Channel (PRACH), a Physical Uplink Control Channel (PUCCH), and a Sounding Reference Signal (SRS) channels which are received by the base station. Some of the channels in both the downlink channel (PBCH, PDCCH and PDSCH) and the uplink channel (PUCCH and PUSCH) also have associated demodulated reference signals with them. All these channels/modules need to be processed within a slot. i.e., with a time, constraint of 500 us considering the 5G NR system operates with a 30 KHz sub-carrier spacing.

Typically, use of a (De) mapping process amongst the channels/modules is quite complex. Each downlink chain processes the data and provides outputs as slot-by-slot to the mapping process for the on-air transmission. In the uplink direction, the on-air data is received by the de-mapping process and each uplink chain is given its respective allocated data to start the decoding. In the FPGA, for an implementation of resource element mapping process of the downlink, a straight forward approach may be used so as to have individual modules handle data collection and generation functions involved in the mapping process.

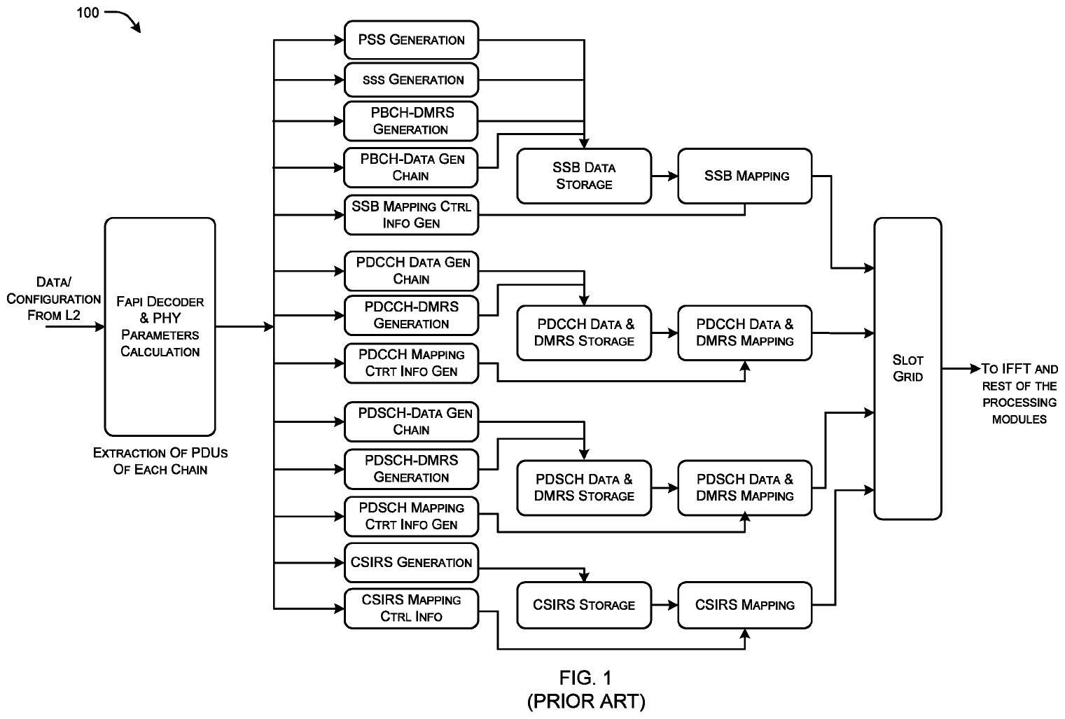

FIG. 1 illustrates an exemplary representation (100) for handling resource element mapping process of downlink in Field Programmable Gate Arrays (FPGA), according to conventional approaches. With respect to FIG. 1, there are provided storage entities for collection of output data of each processing chain i.e. SSB storage entity (containing PSS, SSS, PBCH and PBCH-DMRS, PDCCH storage entity (containing PDCCH chain output and PDCCH-DMRS), PDSCH storage entity (containing PDSCH chain output and PDSCH-DMRS), CSIRS storage entity (containing CSIRS sequence). Further, are provided entities for mapping of each channel's stored data (SSB, PDCCH, PDSCH and CSIRS) onto slot grid for on-air transmission. This implementation involves a complex mechanism of creating and managing synchronization between these tasks since mapping entity is dependent on completion of data reception and data generation entities. Also, an additional logic may be needed to manage interdependency of each of the entity.

Therefore, the present disclosure describes an efficient way of handling such complex block designs by implementing/integrating all the entities of resource element (de)mapping process, i.e. data collection, data generation and data mapping into a single block/function. Also, is defined an intelligent way of handling storage memory of copied and generated data, such that, the data is available for being dispatched to rest of transmission chain. This enables to reduce complexity of managing separate FPGA entities and embedding all intelligence into a single one.

The disclosed system and method facilitates to provide a resource element (De) mapper design in a single FPGA module for handling data collection, data generation, and data dispatch entities concurrently. The disclosed system and method enable creation of parallel sub-data collection entities within the master data collection entity and of serial sub-data generation entities within the master data generation entity. In addition, the disclosed system and method enables creation of data dispatch entities which outputs the stored data serially (one after another) and in parallel to the data collection and generation entities.

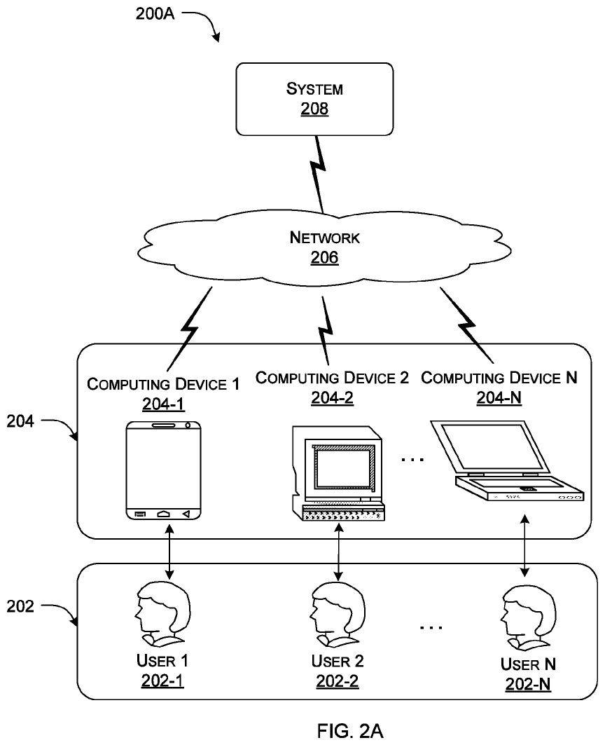

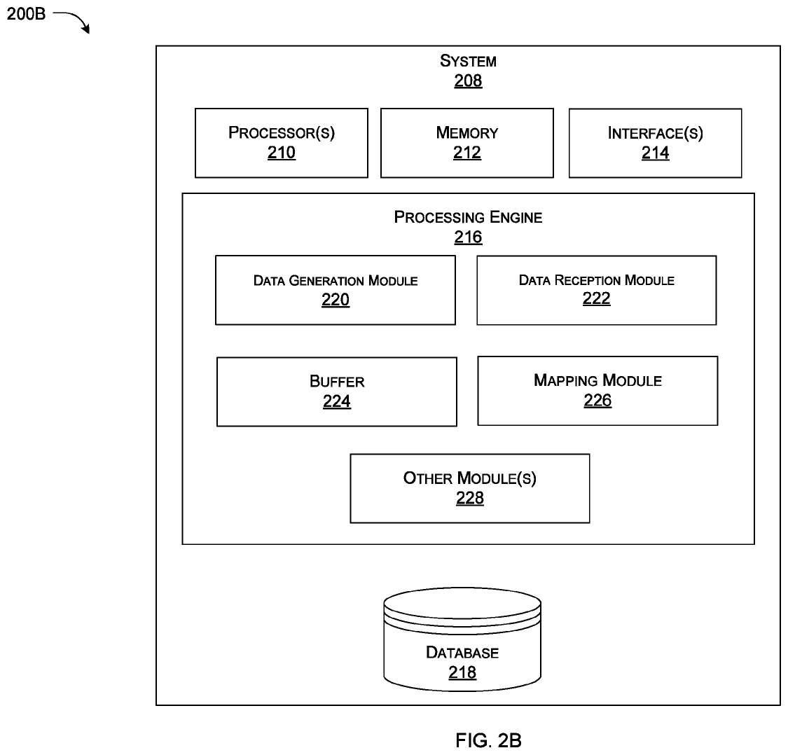

Various embodiments of the present disclosure will be explained in detail with reference to FIGS. 2-4.

FIG. 2A illustrates an exemplary network architecture (200A) in which or with which embodiments of the present disclosure may be implemented.

As illustrated in FIG. 2A, by way of an example and not by limitation, the exemplary network architecture (200) may include a plurality of computing devices (204-1, 204-2 . . . 204-N), which may be individually referred as the computing device (204) and collectively referred as the computing devices (204). The plurality of computing devices (204) may include, but not be limited to, scanners such as cameras, webcams, scanning units, and the like configured to send a request or an input including a plurality of control parameters to a system (208). The control parameters may include, but not limited to, a length of control data, a Radio Network Temporary Identifier (RNTI), a Physical Cell Identity (PCI), a Synchronization Signal Block (SSB) index, and an aggregation level of one or more channels.

In an embodiment, the computing device (204) may include smart devices operating in a smart environment, for example, an Internet of Things (IoT) system. In such an embodiment, the computing device (204) may include but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof.

A person of ordinary skill in the art will appreciate that the computing device or a user equipment (204) may include, but is not limited to, intelligent, multi-sensing, network-connected devices, that may integrate seamlessly with each other and/or with a central server or a cloud-computing system or any other device that is network-connected.

In an embodiment, the computing device (204) may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the computing device (204) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device (204) may include one or more in-built or externally coupled accessories including, but not limited to, a visual aid device such as a camera, an audio aid, a microphone, a keyboard, and input devices for receiving input from the user or the entity such as touch pad, touch enabled screen, electronic pen, and the like. A person of ordinary skill in the art may appreciate that the computing device (204) may not be restricted to the mentioned devices and various other devices may be used.

In an exemplary embodiment, the computing device/user equipment (204) may communicate with the system (208) through a network (206). The network (206) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (206) may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

Although FIG. 2A shows exemplary components of the network architecture (200A), in other embodiments, the network architecture (200A) may include fewer components, different components, differently arranged components, or additional functional components than depicted in FIG. 2A. Additionally, or alternatively, one or more components of the network architecture (200A) may perform functions described as being performed by one or more other components of the network architecture (200A).

FIG. 2B illustrates an exemplary block diagram (200B) of a system (208), in accordance with an embodiment of the present disclosure.

The system (208) may include a processor(s) (210), a memory (212), an interface (214), a processing engine (216), and a database (218). The memory (212) is operatively coupled to the one or more processors (210). The one or more processors (210) may be implemented as one or more microprocessors, microcomputers, microcontrollers, digital signal processors, central processing units, logic circuitries, and/or any devices that manipulate data based on operational instructions. Among other capabilities, the one or more processor(s) (210) may be configured to fetch and execute computer-readable instructions stored in the memory (212) of the system (208). The memory (212) may store one or more computer-readable instructions or routines, which may be fetched and executed to create or share the data units over a network service. The memory (212) may include any non-transitory storage device including, for example, volatile memory such as Random-Access Memory (RAM), or non-volatile memory such as Erasable Programmable Read-Only Memory (EPROM), flash memory, and the like.

In an embodiment, the system (208) may also include an interface(s) (214). The interface(s) (214) may comprise a variety of interfaces, for example, a variety of interfaces, for example, interfaces for data input and output devices, referred to as I/O devices, storage devices, and the like. The interface(s) (214) may facilitate communication of the system (208) with various devices coupled to it. The interface(s) (214) may also provide a communication pathway for one or more components of the system (208). Examples of such components include but are not limited to, processing engine (216) and database (218).

In an embodiment, the processing engine (216) may be implemented as a combination of hardware and programming (for example, programmable instructions) to implement one or more functionalities of the processing engine (216). In the examples described herein, such combinations of hardware and programming may be implemented in several different ways. For example, the programming for the processing engine (216) may be processor-executable instructions stored on a non-transitory machine-readable storage medium and the hardware for one or more processors (210) may comprise a processing resource (for example, one or more processors), to execute such instructions. In the present examples, the machine-readable storage medium may store instructions that, when executed by the processing resource, implement the processing engine (216). In such examples, the system (208) may comprise the machine-readable storage medium storing the instructions and the processing resource to execute the instructions, or the machine-readable storage medium may be separate but accessible to the system (208) and the processing resource. In other examples, the processing engine (216) may be implemented by an electronic circuitry. The database (218) may include data that is either stored or generated as a result of functionalities implemented by any of the components of the processing engine(s) (216).

The processing engine (216) may include a data generation module (220), a data collection module (222), a mapping module (226), a buffer (224), and other module(s) (228). The data generation module (220) may generate data corresponding to downlink channels, where the downlink channels may include at least one of a Primary Synchronization Signal (PSS), a Secondary Synchronization Signal (SSS), a Demodulated Reference Signal (DMRS) for a Physical Broadcast Channel (PBCH), and a Channel State Information Reference Signal (CSIRS). While generating the data corresponds to the downlink channels, the data collection module (222) may receive data from processing channels, where the processing channels correspond to a PBCH, a Physical Downlink Control Channel (PDCCH), a Physical Downlink Shared Channel (PDSCH), a DMRS value for the PDCCH and the PDSCH. The data generation and the data reception from the processing channels are performed concurrently.

In an embodiment, the data corresponding to the PSS is generated serially with the SSS. In an embodiment, the information corresponding to the PBCH is received serially with the PDCCH. After the generation and reception of the data, the buffer (224) may receive the generated data and the reception data from the data generation module (220) and the data reception module (222). Also, the buffer (224) may store the generated data and the reception data based on slot-by-slot.

The mapping module (226) may receive mapping information from a slot tag grid (not shown in FIG. 2B) and may determine whether both the generated data and the received data are completely stored in the buffer (224) or not. When the generated data and the received data are completely stored in the buffer (224), the mapping module (226) may sequentially fetch the stored data from the buffer (224) using the mapping information. For example, the mapping module (226) may determine whether a previous slot of the buffer (224) is filled or not and also may determine whether a current slot of the buffer (224) is being utilized for storing the generated data and the received data. Once the mapping module (226) determines the previous slot of the buffer is filled and the current slot of the buffer (224) is being utilized for storing the generated data and the received data, the mapping module (226) may first fetch the data from the previous slot of the buffer. Similarly, for example, when the mapping module (226) may determine the previous slot of the buffer is not filled, the mapping module (226) may hold the fetching procedure till the generated data and the received data are completely stored in the slots.

Once the data is fetched, the mapping module (226) may map the stored data at an appropriate position in a slot grid, where the mapping information may include information of data presence of allocated physical channels for each of the Physical Resource Blocks (PRBs) of the slot grid. The system (208) may transfer the mapped data serially to a modulator block (not shown in FIG. 2B). While transferring the mapped data, the output sequence is frequency first then time domain data. The other module(s) (228) may implement functionalities that supplement applications/functions performed by the processing engine 203.

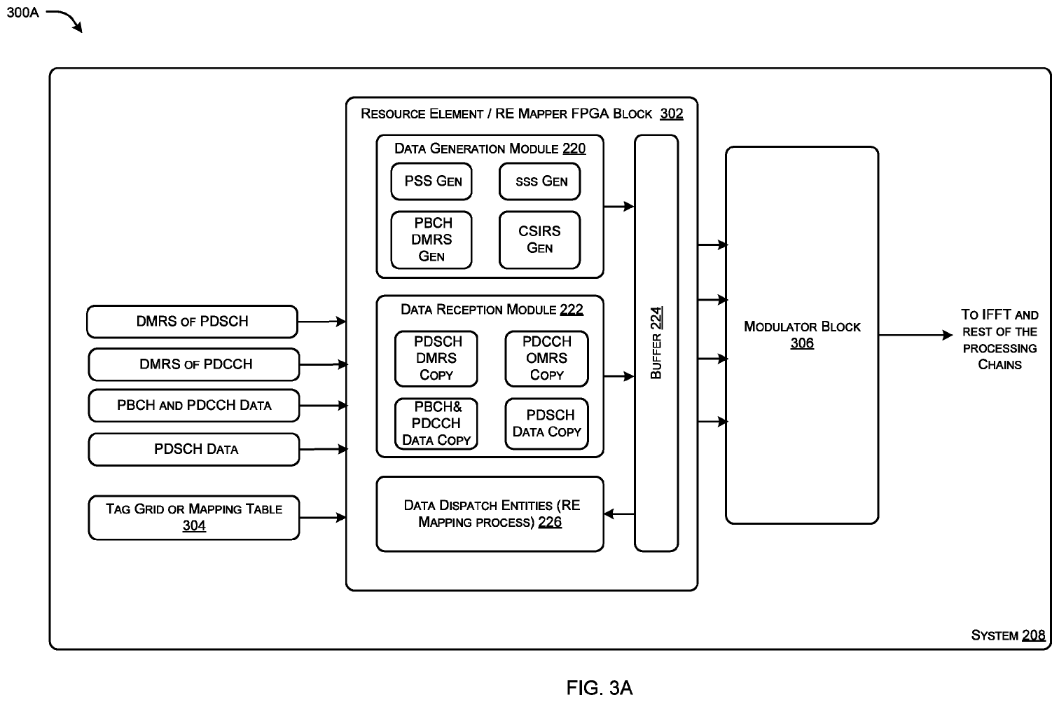

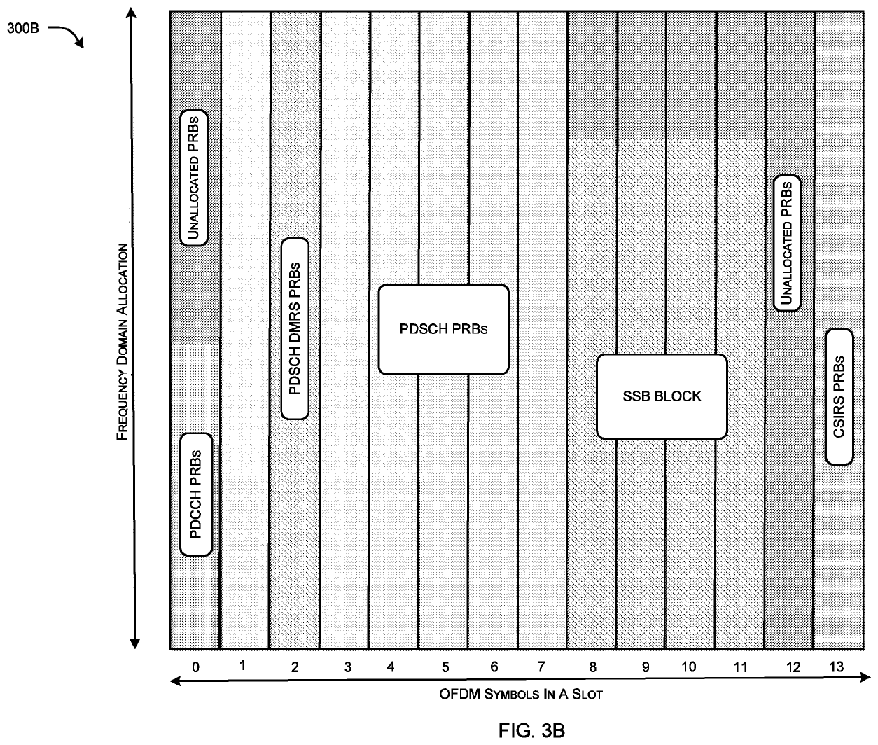

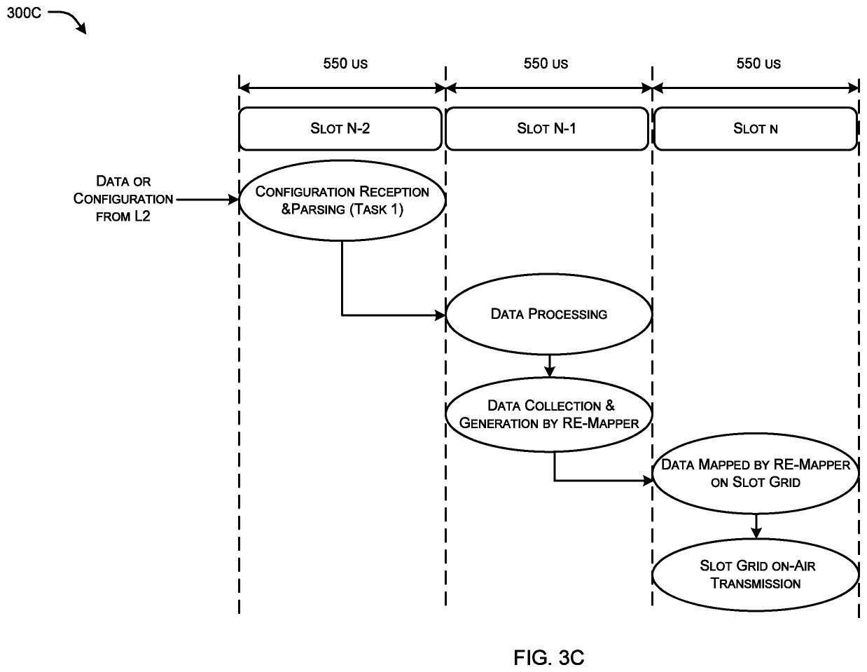

FIG. 3A illustrates an exemplary representation (300A) of a RE-Mapper FPGA block (302), in accordance with an embodiment of the disclosure.

The RE-Mapper FPGA block (302) may take inputs from various data processing chains/channels as well as the control information. The output is a multi-layer antenna data given to a modulator block. A mapping table (slot tag grid vector) (304) is a control buffer that contains the information of data presence of every physical channel (SSB, PDCCH, PDSCH, DMRS of PDSCH and PDCCH and CSIRS) in each PRB of slot gird and is given to the RE-Mapper block (302). Along with it, the DMRS values for the PDCCH and PDSCH channels are also computed separately and provided to the RE-Mapper FPGA block (302). PDSCH Data, PDCCH data, and PBCH Data are processed in their respective FPGA blocks and final outputs are provided to the RE-Mapper block.

The synchronization signal (PSS and SSS), PBCH-DMRS, and CSIRS sequence are generated locally, as control information required to generate them is comparatively less as compared to other physical channels.

The RE-Mapper FPGA block (302) is designed to perform collection and generation functions/entities along with the dispatch of the data onto the slot grid. These entities and the sub-functions/entities are described as a master data generation module/entity (220), a master data reception module/entity (222), and data dispatch entities (226) i.e., a mapping module (226) of a system (208). The master data generation entity (220) is running concurrently with various sub-functions. These concurrent sub-entities are such as the generation of PSS serially with SSS, the generation of PBCH-DMRS, and the generation of CSIRS data.

The master data reception entity (222) is running concurrently with various sub-functions to copy the data being generated from various FPGA channels/blocks. These concurrent sub-entities such as copy of the PDSCH-DMRS, copy of the PDCCH-DMRS, serial data copy of the PBCH and the PDCCH chain, and copy of the PDSCH Data. The copied/collected and generated data is stored at the buffer (224).

The dispatch entities (226) fetches the data. Once it is copied and generated by the other two entities i.e., the data reception entity (222) and the generation entity (220), it takes the stored data from the specific buffers using the tag grid/mapping table (304) and maps the data onto the slot grid. The data is provided in the output streams of the RE-Mapper block (302) in frequency first then time manner of the resource elements of the slot grid. The output data is provided to a modulator block (306) which is generic modulator performing applicable modulation i.e. QPSK, 16QAM, 64QAM or 256 QAM, pilot power boosting and phase pre-compensation. The modulator block (306) may send the data further to the Inverse Fast Fourier Transform (IFFT) block and rest of the processing chains for on-air transmission.

FIG. 3B illustrates an exemplary representation (300B) of downlink slot containing various physical channels mapped onto slot grid, in accordance with an embodiment of the present disclosure.

A 5G NR is a Radio Access Technology (RAT) developed by 3GPP for the fifth generation (5G) mobile network. It is designed to be a global standard for air interface of the 5G network. This is based on Orthogonal Frequency-Division Multiplexing (OFDM) as with 4G (long-term evolution (LTE)) network. The 3GPP specification 38 series provide technical details of the 5G NR, which is a successor of the LTE. In the LTE, there is only type of numerology or subcarrier spacing (i.e., 15 KHz), whereas in the NR multiple types of subcarriers spacing are available. For example, the 5G NR supports subcarrier spacing of 15, 30, 60, 120, and 240 KHz. Not all numbers can be used for every physical channel and signals. There are a specific set of numbers that are used only for a certain type of physical channels even though majority of the numbers may be used for any type of the physical channels. Typically, the 5G NR covers a very wide range of frequencies (e.g., sub 3 GHZ, sub 6 GHz and mm-Wave over 25 GHz) and each of the frequency range has its own characteristics in term of propagation, Doppler, inter symbol interference etc. and to achieve maximum efficiency or performance, multiple subcarrier options are used.

In the 5G NR, the base station consists of various downlink and uplink physical channels as defined by 3GPP standards. In downlink there is SSB containing PSS, SSS, PBCH and PBCH-DMRS along with other channels which are PDCCH, PDSCH and CSIRS. In uplink there is PRACH, PUSCH, PUCCH and SRS. The 3GPP defines each of the channel/chain processing as well as the mapping process involved in each one of them.

One of the channels involved here is SSB that contains PSS, SSS and PBCH and PBCH-DMRS. Generation of the PSS and the SSS is dependent only on cell id. Generation of the PBCH-DMRS is from a PN sequence generator which uses cell id and symbol number as seed.

Another involved channel is PDCCH. The PDCCH is used to carry Downlink Control Information (DCI). The DCI contains information used to schedule user data (i.e., PUSCH in uplink and PDSCH in downlink.) The PDCCH channel is present in interleaved or continuous pattern in CORESET region of slot grid. The PDCCH-DMRS is generated using PN sequence generator and it occupies fixed places in the PDCCH PRB i.e., 2nd, 6th and 10th position among 12 subcarriers of each PRB.

Yet another channel is PDSCH. This channel carries downlink user specific data, UE specific upper layer information and broadcast messages like system information and paging. The generation of PDSCH data is a most exhaustive process of Layer 1 requiring huge data processing. A PN sequence generator is used to generate the PDSCH DMRS bits.

Further is disclosed a CSIRS that is used in downlink for the purpose of radio channel characteristics measurement. The UE uses this channel to measure the channel information (e.g., RSRP, RSRQ, SINR, RI, CQI, PMI etc.) and report it back to the network. The CSIRS sequence is generated using a PN sequence generator with scrambling id, slot number and allocated symbol being used for seed calculation.

Next, a standard interface is provided, where physical layer channel's configuration exchange happens between Layer 1 and Layer 2 through a FAPI interface. The downlink and uplink Transmission Time Interval (TTI) messages are sent from the Layer 2 to the Layer 1 through Femto Application Platform Interface (FAPI) interface/standard as per TTI. The 5G FAPI published by the Small Cell Forum (SCF) is a suite of specifications that enable small cells to be built up piece-by-piece using components from different suppliers. It can be viewed as a subset of the network Functional Application Platform Interface (nFAPI), also published by the SCF. The Packet Data Units (PDUs) received from L2 consists of allocation parameters and channel data, and payload of each of the channels is processed as per steps defined in the 3GPP standard. Mapping of the processed data onto a slot grid is done and subsequently the slot grid is passed on to radio unit for on-air transmission.

The disclosed system and method provide an efficient solution for handling various channels data, map the channels data to build a single FPGA block (alias RE-Mapper block), and manage intricacies of all individual processes inside it. Three master entities implemented in the disclosed system and method is: (i) generation of data, (ii) collection of data, and (iii) mapping of data. All of the three entities run simultaneously. The mapping process requires availability of all of the slot data before starting its execution and thus the generation and collection of data of a slot has to be completed before the mapping of that slot data begins. The data of all the channels is copied/saved in the internal buffers in one slot and in the next slot, the saved data of previous slot is mapped to its appropriate position in the slot gird and given to modulator block while the data generation and collection is processing concurrently for current slot.

In an embodiment, the disclosed system and method enables creation of parallel sub-data collection entities within the master data collection entity. Further, the disclosed system and method facilitates creation of serial sub-data generation entities within the master data generation entity (220). Also, is facilitated creation of data dispatch entities which outputs the stored data serially (one after another) and in parallel to the data collection and generation entities.

FIG. 3C illustrates an exemplary representation (300C) for storing and mapping data alternatively, in accordance with an embodiment of the disclosure.

All the entities run concurrently, wherein the dispatch entity maps the data of previous slot. Further, the collection and generation entities work on the data of the current slot. Also, ping and pong buffers are used to store and map data alternatively. Copy and generation functions fills one of them in alternate slot, and map function uses the other one i.e., when the copy function is filling ping buffers in slot N−1 then map function uses these ping buffers in slot N. FIG. 3C illustrates timing diagram of layer 1 process flow per slot, in accordance with an embodiment of the disclosure. With respect to FIG. 3C, when data or configuration is received from L2, then at slot N2 configuration reception and parsing, i.e., task 1 is performed. Next at slot N1, data processing is performed and data collection and generation is performed by RE mapper. Thereafter, at slot N, data is mapped by RE mapper on slot grid which is then further processed for the on-air transmission.

The disclosed system and method facilitate to reduce complexity of development of re-(de)mapping processes by providing accessibility of all various input streams inside a single module. In addition, disclosed the system and method enables ease of doing maintenance and debugging of all the re-(de)mapping processes by using a single module. The disclosed system and method may be implemented in an outdoor small cell (ODSC) product that is based on FPGA platform.

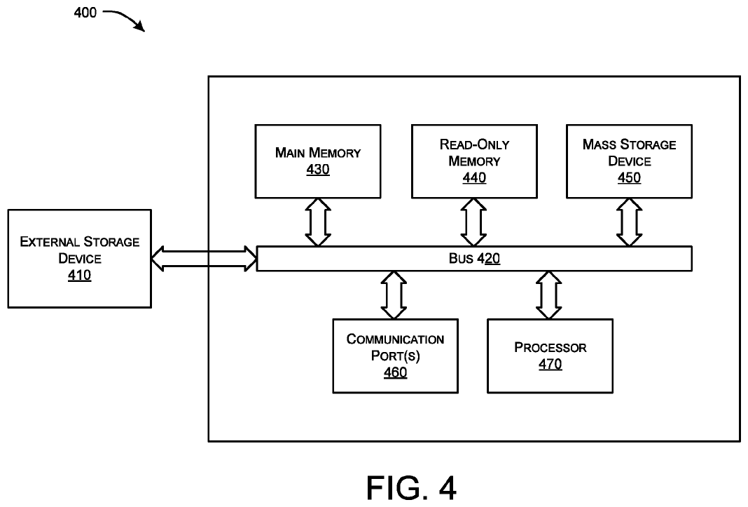

FIG. 4 illustrates an exemplary computer system (400) in which or with which embodiments of the present invention can be utilized in accordance with embodiments of the present disclosure. As shown in FIG. 4, computer system (400) can include an external storage device (410), a bus (420), a main memory (430), a read only memory (440), a mass storage device (450), communication port (460), and a processor (470). A person skilled in the art will appreciate that the computer system may include more than one processor and communication ports. Processor (470) may include various modules associated with embodiments of the present invention. Communication port(s) (460) can be any of an RS-232 port for use with a modem-based dialup connection, a 10/100 Ethernet port, a Gigabit or 10 Gigabit port using copper or fiber, a serial port, a parallel port, or other existing or future ports. Communication ports(s) (460) may be chosen depending on a network, such a Local Area Network (LAN), Wide Area Network (WAN), or any network to which computer system connects. Memory (430) can be Random Access Memory (RAM), or any other dynamic storage device commonly known in the art. Read-only memory (440) can be any static storage device(s) e.g., but not limited to, a Programmable Read Only Memory (PROM) chips for storing static information e.g., start-up or BIOS instructions for processor (470). Mass storage (450) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

Bus (420) communicatively couples processor(s) (470) with the other memory, storage and communication blocks. Bus (420) can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor (470) to software system.

Optionally, operator and administrative interfaces, e.g. a display, keyboard, joystick and a cursor control device, may also be coupled to bus (420) to support direct operator interaction with a computer system. Other operator and administrative interfaces can be provided through network connections connected through communication port (460). Components described above are meant only to exemplify various possibilities. In no way should the aforementioned exemplary computer system limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a system and a method to reduce complexity of development of re-(de)mapping processes by providing the accessibility of all the various input streams inside a single module.

The present disclosure provides a system and a method to maintain and debug all the re-(de)mapping processes using a single module.

We claim:

1. A system (208) for managing resource element mapping, comprising:
one or more processors (210); and
a memory operatively coupled to the one or more processors (210), wherein the memory comprises processor-executable instructions, which on execution, cause the one or more processors (210) to:
generate data corresponding to one or more downlink channels at one or more data generation modules (220) associated with the system (208), wherein the one or more downlink channels comprise at least one of: a Primary Synchronization Signal (PSS), a Secondary Synchronization Signal (SSS), a Demodulated Reference Signal (DMRS) for a Physical Broadcast Channel (PBCH), and a Channel State Information Reference Signal (CSIRS),
receive data from one or more processing channels at one or more data reception modules (222) associated with the system (208), wherein the one or more processing channels correspond to at least one of: a PBCH and a Physical Downlink Control Channel (PDCCH), a Physical Downlink Shared Channel (PDSCH), a DMRS for the PDCCH and the PDSCH;
store the generated data and the received data in a buffer (224) associated with the system (208),
map the stored data at one or more data dispatch entities (226) associated with the system (208) at an appropriate position in a slot grid; and
transfer the mapped data, by the one or more data dispatch entities (226) associated with the system (208), serially to a modulator associated with the system (208) based on a frequency and a time of a resource element of the slot grid.

2. The system (208) as claimed in claim 1, wherein the data corresponding to the PSS is generated serially with the data corresponding to the SSS.

3. The system (208) as claimed in claim 1, wherein the data corresponding to the PBCH is received serially with the data corresponding to the PDCCH.

4. The system (208) as claimed in claim 1, wherein the generation of the data corresponding to the one or more downlink channels and the reception of the data from the one or more processing chains are performed concurrently.

5. The system (208) as claimed in claim 1, wherein the one or more processors (210) are to:
receive mapping information from a slot tag grid associated with the system (208);
determine that the generated data and the received data are completely stored in the buffer (224); and
sequentially fetch the stored data from the buffer (224) using the mapping information to map the fetched data at the appropriate position in the slot grid.

6. The system (208) as claimed in claim 5, wherein the slot tag grid comprises the mapping information of the allocated physical downlink channels for each of the Physical Resource Blocks (PRBs) of the slot grid.

7. The system (208) as claimed in claim 5, wherein the one or more processors (210) are to sequentially fetch the stored data from the buffer (224) by being configured to:
determine that a previous slot of the buffer (224) is filled and a current slot of the buffer (224) is utilized for storing the generated data and the received data; and
in response to the determination, fetch the data from the previous slot of the buffer (224) to map the fetched data at the appropriate position in the slot grid.

8. A method for managing resource element mapping, comprising:
generating, by one or more processors (210), data corresponding to one or more downlink channels at one or more data generation modules (220) associated with a system (208), wherein the one or more downlink channels comprise at least one of: a Primary Synchronization Signal (PSS), a Secondary Synchronization Signal (SSS), a Demodulated Reference Signal (DMRS) for a Physical Broadcast Channel (PBCH), and a Channel State Information Reference Signal (CSIRS),
receiving, by the one or more processors (210), data from a plurality of processing channels at one or more data reception modules (222) associated with the system (208), wherein the one or more processing channels correspond to at least one of: a PBCH, a Physical Downlink Control Channel (PDCCH), a Physical Downlink Shared Channel (PDSCH), a DMRS value for the PDCCH and the PDSCH;
storing, by the one or more processors (210), the generated data and the received data in a buffer (224) associated with the system (208);
mapping, at one or more data dispatch entities (226) associated with the system (208), the stored data at an appropriate position in a slot grid; and
transferring, by the one or more data dispatch entities (226) associated with the system (208), the mapped data serially to a modulator associated with the system (208) based on a frequency and a time of a resource element of the slot grid.

9. The method as claimed in claim 8, wherein the data corresponding to the PSS is generated serially with the data corresponding to the SSS.

10. The method as claimed in claim 8, wherein the data corresponding to the PBCH is received serially with the data corresponding to the PDCCH.

11. The system (208) as claimed in claim 8, wherein the generation of the data corresponding to the one or more downlink channels and the reception of the data from the one or more processing chains are performed concurrently.

12. The method as claimed in claim 8, wherein mapping, by the one or more processors (210), the stored data at the appropriate position in the slot grid comprises:
receiving, by the one or more processors (210), mapping information from a slot tag grid associated with the system (208);
determining, by the one or more processors (210), that the generated data and the received data are completely stored in the buffer (224); and
sequentially fetching, by the one or more processors (210), the stored data from the buffer (224) using the mapping information to map the fetched data at the appropriate position in the slot grid.

13. The method as claimed in claim 12, wherein the slot tag grid comprises the mapping information of the allocated physical downlink channels for each of the Physical Resource Blocks (PRBs) of the slot grid.

14. The method as claimed in claim 12, wherein sequentially fetching, by the one or more processors (210), the stored data from the buffer (224) using the mapping information comprises:
determining, by the one or more processors (210), that a previous slot of the buffer (224) is filled and a current slot of the buffer (224) is utilized for storing the generated data and the received data; and
in response to the determination, fetching, by the one or more processors (210), the data from the previous slot of the buffer (224) to map the fetched data at the appropriate position in the slot grid.

15. A system (208) for managing resource element de-mapping, comprising:
one or more processors (210); and
a memory operatively coupled to the one or more processors (210), wherein the memory comprises processor-executable instructions, which on execution, cause the one or more processors (210) to:
receive mapped slot data serially corresponding to one or more uplink channels, wherein the one or more uplink channels comprises at least one of a Physical Uplink Shared Channel (PUSCH), a Physical Uplink Control Channel (PUCCH), and a Sounding Reference Signal (SRS);
de-map the mapped data using a slot tag grid; and
output the de-mapped data in parallel using data dispatch entities (226) to different uplink processing chains to decode the de-mapped data.

16. A non-transitory computer-readable medium comprising processor-executable instructions that cause a processor to:
generate data corresponding to one or more downlink channels at one or more data generation modules (220) associated with a system (208), wherein the one or more downlink channels comprise at least one of: a Primary Synchronization Signal (PSS), a Secondary Synchronization Signal (SSS), a Demodulated Reference Signal (DMRS) for a Physical Broadcast Channel (PBCH), and a Channel State Information Reference Signal (CSIRS);
receive data from one or more processing channels at one or more data reception modules (222) associated with the system (208), wherein the one or more processing channels correspond to at least one of: a PBCH and a Physical Downlink Control Channel (PDCCH), a Physical Downlink Shared Channel (PDSCH), a DMRS for the PDCCH and the PDSCH;
store the generated data and the received data in a buffer (224) associated with the system (208);
map the stored data at one or more data dispatch entities (226) associated with the system (208) at an appropriate position in a slot grid; and
transfer, by the one or more data dispatch entities (226), the mapped data serially to a modulator block associated with the system (208) based on a frequency and a time of a resource element of the slot grid.
